(19) United States
(12) Patent Application Publication
(10) Pub. No.: US 2003/0011715 A1
(43) Pub. Date: Jan. 16, 2003

(54) Method and system for enhancing a graphic overlay on a video image

(76) Inventor: John A. Kastelic, Cleveland, OH (US)

Correspondence Address: John A. Kastelic, 17828 Rosecliff Road, Cleveland, OH, 44119, US

(21) Appl. No.: 10/191,934

(22) Filed: Jul. 9, 2002

Related U.S. Application Data
(63) Continuation-in-part of application No. 09/902,415, filed on Jul. 10, 2001.

(51) Int. Cl. H04N 7/18

(52) U.S. Cl. 348/589; 348/157; 348/563; 345/629

(57) ABSTRACT

A method and system for broadcasting activity occurring in a sporting event such as a hockey or baseball game is provided, wherein the activity includes one or more players actively or inactively involved in the sporting event. The method comprises the steps of: (i) providing a video image of activity occurring in the sporting event; (ii) creating a graphic overlay for the video image, the graphic overlay providing indicia representing identity information of the one or more players actively or inactively involved in the sporting event; and (iii) overlying the graphic overlay over the video image to create a combined image comprising the graphic overlay and the video image. In the case of a baseball game, the activity includes one or more actively involved base runners occupying bases in a field where the baseball game is being played, and the indicia representing identity information of the one or more actively involved base runners occupying the bases is provided in the form of uniform numbers of these base runners. In the case of a hockey game, the activity includes one or more inactively involved players occupying a penalty box, and the indicia representing identity information of the one or more inactively involved players occupying the penalty box is provided in the form of uniform numbers of these players.

### RELATED APPLICATION

The present application is a continuation-in-part (CIP) of U.S. patent application Ser. No. 09/902,415, entitled Method and System for Enhancing a Graphic Overlay on a Video Image, filed Jul. 10, 2001.

### FIELD OF THE INVENTION

The present invention relates generally to enhancement of graphic overlays on video images, and more specifically to enhancement of such overlays on video images such as television broadcasts of sporting events.

### BACKGROUND OF THE INVENTION

Television broadcasts of sporting events present viewers with real-time, or in some cases videotaped or delayed, video images of the sporting event. Enhancements to such video images are known. For example, graphic overlays are often provided by the broadcaster to provide information to the viewer that is not readily ascertainable from merely viewing the currently displayed video image of the sporting event.

FIG. 1A shows a depiction of a prior art graphic overlay provided with a broadcast video image of a first sporting event, in this case, a major league baseball game. As shown in FIG. 1A, a video image 12A of activity occurring in the baseball game is broadcast to a television monitor or receiver providing a viewing screen 14A. As used herein, “broadcast” is meant to include any means of providing the video image and overlay to the viewer, for example, by conventional through-the-air broadcasting, by cable, or by videotape or other delayed means.

A graphic overlay 16A is provided within the confines of the viewing screen 14A, overlying the video image 12A. Typically, the graphic overlay 16A occupies only a small portion of the viewing screen 14A so that the graphic overlay can be displayed without significantly interfering with the viewer's ability to view the video image 12A. As shown in FIG. 1A, the video image 12A is that of a baseball player batting. Accordingly, the information provided by the graphic overlay 16A may be viewed concurrently by the viewer while the video image is being viewed.

The graphic overlay 16A provides information to the viewer that is not readily ascertainable from viewing the video image 12A of the activity occurring in the baseball game. For example, the graphic overlay in FIG. 1A identifies the competing teams 18 (conventionally the home team is listed below the visiting team); the team that is currently batting is identified by asterisk 20; the score 22; the pitch count 24; the number of outs 26; the inning 28; the identity of the broadcaster 30 providing the broadcast; and the bases 32 currently occupied by base runners.

As shown in FIG. 1A, the graphic overlay 16A shows that first and second bases on the field where the baseball game is being played are occupied by base runners, and third base is unoccupied. Indicia are provided at the locations of first and second base, and no indicia is provided at the location of third base. Alternatively, prior art graphic overlays show indicia at all three base locations, and use some means to alter (e.g., by color change) the bases that are occupied by base runners.

One type of information that is notably missing from known graphic overlays such as overlay 16A is the identity of the actively involved base runners currently occupying the bases on the field where the baseball game is being played. For example, the graphic overlay 16A of FIG. 1A does not provide the viewer with information that would identify the base runners on first and second base. Such information is important to a viewer, as some base runners can typically score from second base on a routine single base hit to the outfield while other base runners typically cannot. Base runner identity information would add to the viewing enjoyment of the game for a viewer.

FIG. 1B shows a depiction of a prior art graphic overlay provided with a broadcast video image of a second sporting event, in this case, a professional league hockey game. As shown in FIG. 1B, a video image 12B of activity occurring in the hockey game is broadcast to a television monitor or receiver providing a viewing screen 14B.

A graphic overlay 16B is provided within the confines of the viewing screen 14B, overlying the video image 12B. Typically, the graphic overlay 16B occupies only a small portion of the viewing screen 14B so that the-graphic overlay can be displayed without significantly interfering with the viewer's ability to view the video image 12B. As shown in FIG. 1B, the video image 12B is that of a hockey player skating and swinging his hockey stick. Accordingly, the information provided by the graphic overlay 16B may be viewed concurrently by the viewer while the video image is being viewed.

The graphic overlay 16B provides information to the viewer that is not readily ascertainable from viewing the video image 12B of the activity occurring in the hockey game. For example, the graphic overlay in FIG. 1B identifies the competing teams 17 (conventionally the home team is listed below the visiting team); the score 21; the period 23; the remaining time 25 in the period; indicia 27 that one or more players is occupying the penalty box (i.e., the words “PWR PLAY”); the remaining time 29 for the player to occupy the penalty box; and the identity of the broadcaster 31 providing the broadcast. The team 17 benefiting from the power play (i.e., the team with more players on the ice) is distinguished from the other team, for example, by highlighting the team 17 in a different color or using an asterisk as shown.

As shown in FIG. 1B, the graphic overlay 16B shows by indicia 27 that one or more players are occupying the penalty box. One type of information that is notably missing from known graphic overlays such as overlay 16B is the identity of the inactively involved hockey player(s) residing in the penalty box. Such information is important to a viewer, and identity information of the penalty box occupier would add to the viewing enjoyment of the game for a viewer.

Thus, it is an object of the present invention to provide a method and system for enhancing graphic overlays on video images, and more specifically to enhancement of such overlays on video images such as television broadcasts of sporting events. It is a further object of the present invention to provide such a method and system for enhancing a graphic overlay, to a video image of a baseball game, in order to provide information relating to the identity of base runners currently occupying the bases in the baseball game. It is still a further object of the present invention to provide such a method and system for enhancing a graphic overlay, to a video image of a hockey game, in order to provide information relating to the identity of players currently occupying the penalty box in the hockey game.

### SUMMARY OF THE INVENTION

A method and system is provided for broadcasting activity occurring in a sporting event, such as a baseball game or hockey game, wherein the activity includes one or more players actively or inactively involved in the sporting event. In a first embodiment, a method and system is provided for broadcasting baseball game activity that includes one or more base runners occupying bases in a field where the baseball game is being played. The method comprises the steps of (i) providing a video image of activity occurring in the baseball game; (ii) creating a graphic overlay for the video image, wherein the graphic overlay provides indicia representing identity information of the one or more base runners occupying bases; and (iii) overlying the graphic overlay over the video image to create a combined image comprising the graphic overlay and the video image. The indicia representing identity information of the one or more base runners occupying bases is provided in the form of uniform numbers of the base runners.

In a second embodiment, a method and system is provided for broadcasting hockey game activity that includes one or more hockey players occupying the penalty box. The method comprises the steps of (i) providing a video image of activity occurring in the hockey game; (ii) creating a graphic overlay for the video image, wherein the graphic overlay provides indicia representing identity information of the one or more hockey players occupying the penalty box; and (iii) overlying the graphic overlay over the video image to create a combined image comprising the graphic overlay and the video image. The indicia representing identity information of the one or more hockey players occupying the penalty box is provided in the form of uniform numbers of the hockey players.

### BRIEF DESCRIPTION OF THE DRAWINGS

FIG. 1A is a depiction of a prior art graphic overlay provided together with a video image of a first sporting event;

FIG. 1B is a depiction of a prior art graphic overlay provided together with a video image of a second sporting event;

FIG. 2A is a depiction of an enhanced graphic overlay, generated according to the present invention, provided together with a video image of a first sporting event;

FIG. 2B is a depiction of an enhanced graphic overlay, generated according to the present invention, provided together with a video image of a second sporting event;

FIG. 3A is an expanded view of the enhanced graphic overlay of FIG. 2A, showing more clearly the enhancement provided by the present invention;

FIG. 3B is an expanded view of the enhanced graphic overlay of FIG. 2B, showing more clearly the enhancement provided by the present invention;

FIG. 4 is a block diagram of a system used to provide the enhanced graphic overlay and video image shown in FIGS. 2A and 2B;

FIG. 5 is a block diagram of the graphic overlay generator shown in the system of FIG. 4; and

FIG. 6 is a block diagram of the graphic overlay memory used in the graphic overlay generator of FIG. 5.

### DETAILED DESCRIPTION OF A PREFERRED EMBODIMENT OF THE INVENTION

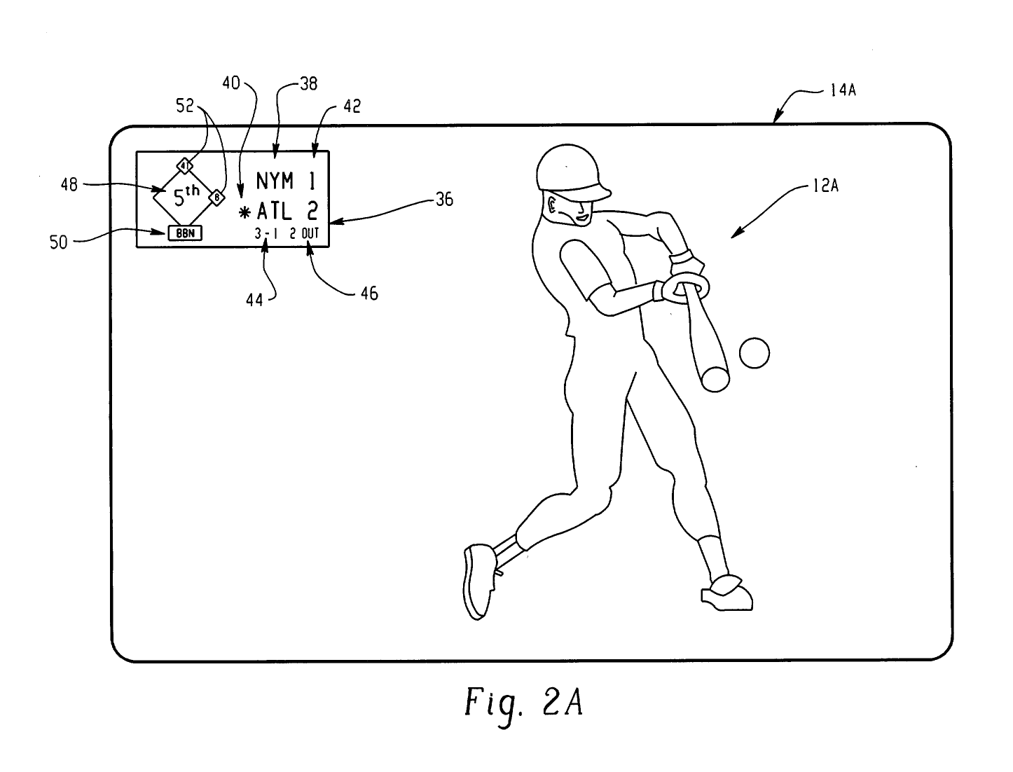

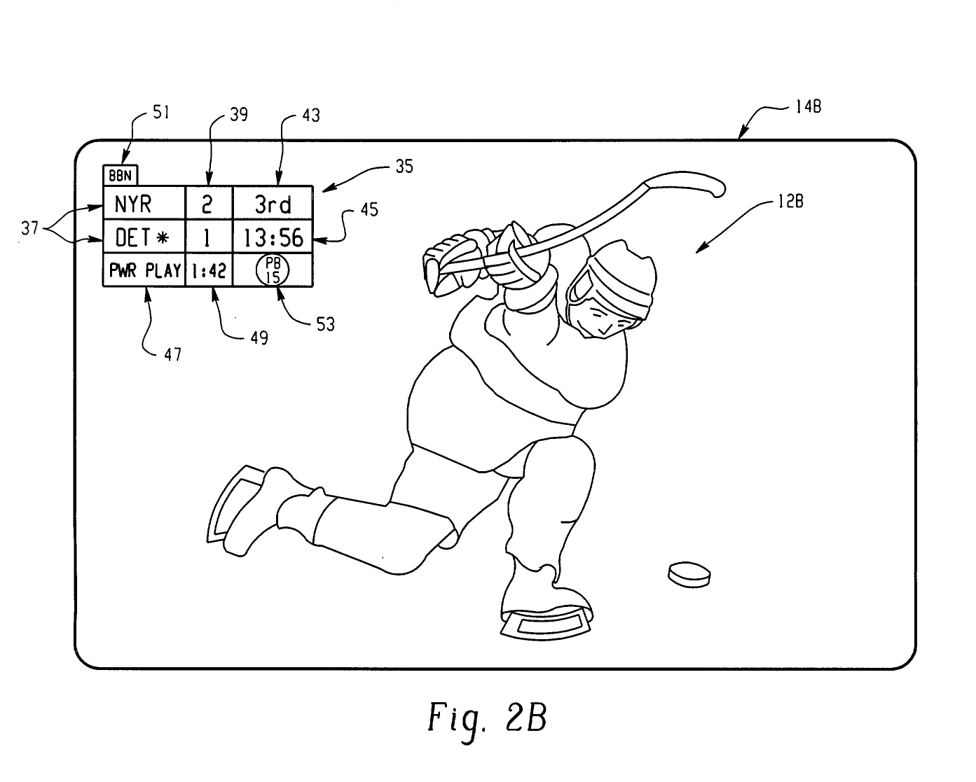

Referring now to FIG. 2A, an enhanced graphic overlay 36 is provided for a video image 12A of activity occurring in a baseball game. The video image 12A and graphic overlay 36 are broadcast to a television monitor or receiver providing a viewing screen 14A. The video image 12A may be a real-time image of activity as it occurs in the game, or it may be a videotaped or otherwise time delayed broadcast.

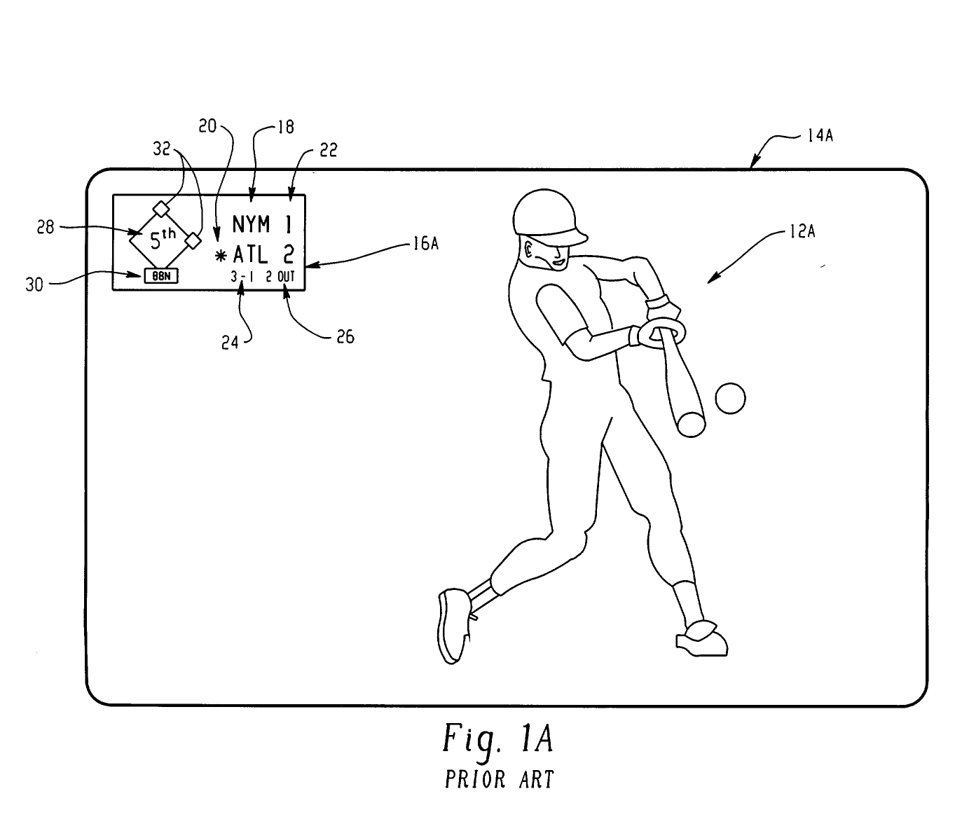

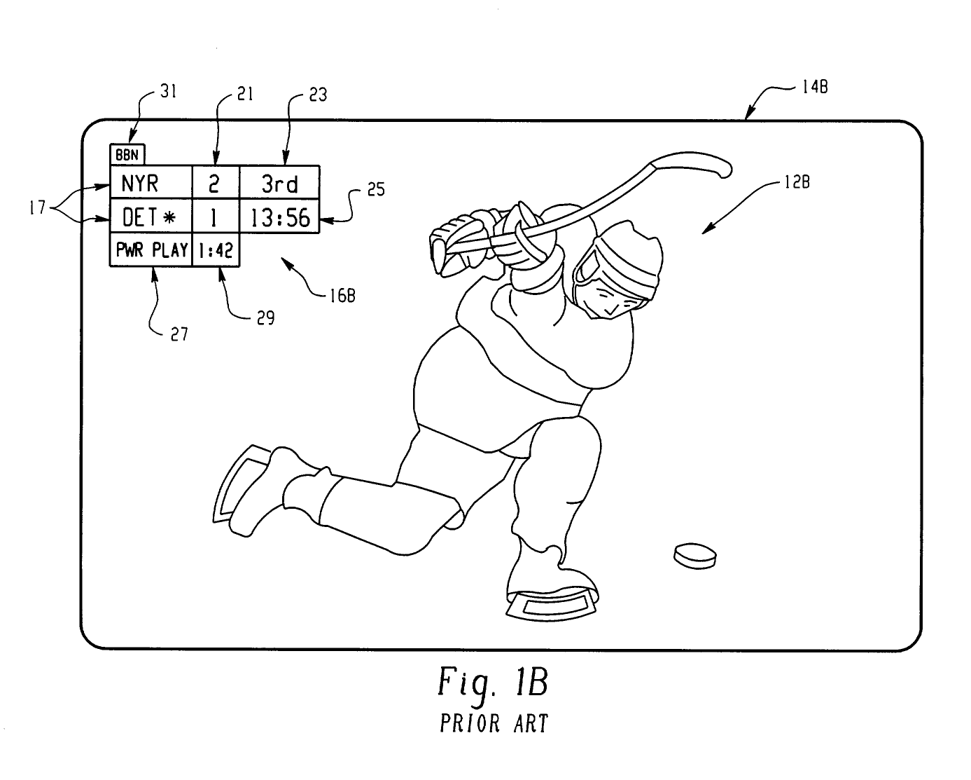

The enhanced graphic overlay 36 provides information to the viewer that may not be readily ascertainable from viewing the video image 12A of the activity occurring in the baseball game, and preferably occupies only a minor portion (i.e., less than 20%) of the video image. The enhanced graphic overlay 36 provides some information that is similar to that provided by the prior art graphic overlay 16A of FIG. 1A. For example, the enhanced graphic overlay 36 identifies the competing teams 38 (conventionally the home team is listed under the away team); the team that is currently batting is identified by asterisk 40; the score 42; the pitch count 44; the number of outs 46; the inning 48; and the identity of the broadcaster 50.

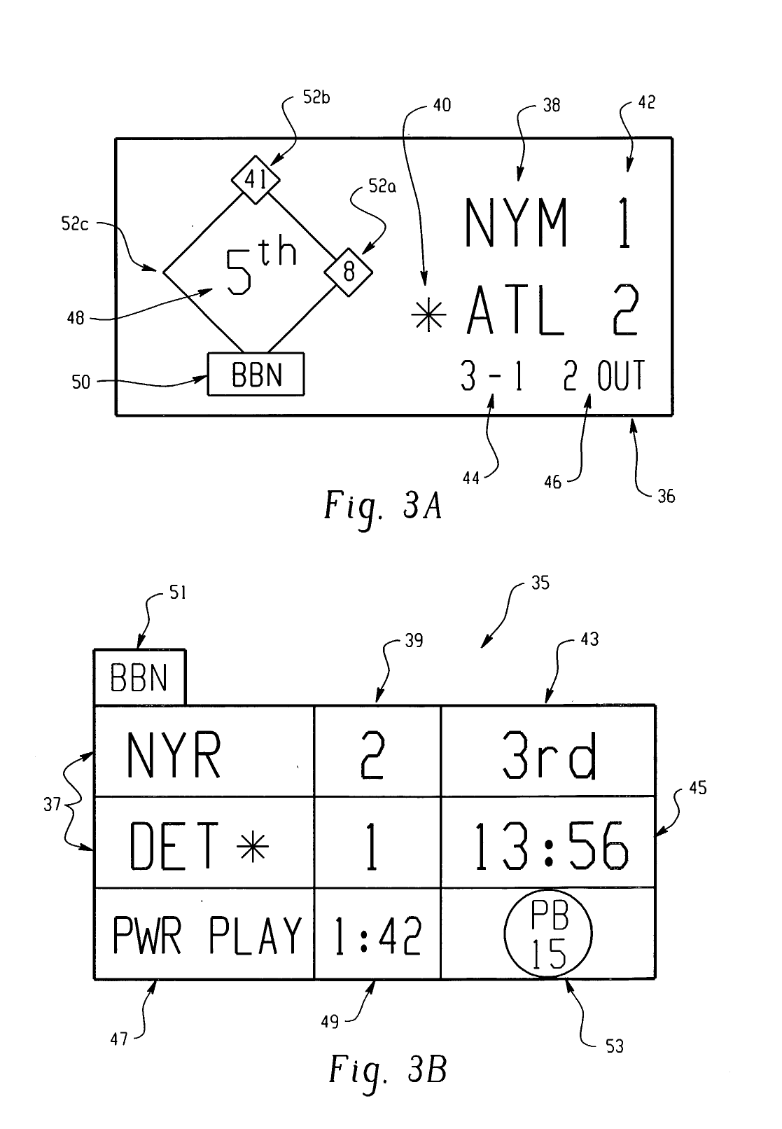

As used herein, the term “graphic overlay” shall mean any indicia that is overlaid upon or provided together with a video image that is not purely textual in nature. For example, both the prior art graphic overlay 16A of FIG. 1A, and the enhanced graphic overlay 36 of FIGS. 2A and 3A include, among other things, an outlined border for the overlay, and a graphic representation of a baseball diamond, i.e., graphically showing the baseball diamond and/or the bases forming the baseball infield.

Also like the prior art graphic overlay 16A of FIG. 1A, the inventive graphic overlay 36 provides information showing the bases 52 that are currently occupied by base runners. As shown in FIG. 2A, the graphic overlay 36 shows that first and second base are occupied by base runners, and that third base is unoccupied. As shown in FIG. 3A, first base is identified by 52a and second base is identified by 52b. No base runner presently occupies third base 52c.

Unlike the prior art graphic overlay 16A of FIG. 1, the inventive graphic overlay 36 also provides information or indicia relating to the identity of the actively involved base runners currently occupying the occupied bases 52a and 52b. In one embodiment, as shown in FIGS. 2A and 3A, the identity information provided are the uniform numbers of the base runners occupying the occupied bases 52a and 52b. As shown, the player assigned uniform number 8 is presently occupying first base 52a, and the player assigned uniform number 41 is presently occupying second base 52b.

Other indicia relating to the identity of the base runners currently occupying the occupied bases 52 is contemplated by the present invention, in place of or in addition to a uniform number. For example, photos or images of the base runners faces can be provided at the locations of occupied bases 52a and 52b. The player's defensive position might be indicated, for example left field (LF). Of course, the expected size of the viewer's screen 14A may influence the detail that might be provided by such photographs or other identification indicia.

Referring now to FIG. 2B, an enhanced graphic overlay 35 is provided for a video image 12B of activity occurring in a hockey game. Like FIG. 1B, the video image 12B (which may be real-time, taped or otherwise time delayed) and graphic overlay 35 are broadcast to a television monitor or receiver providing a viewing screen 14B.

The enhanced graphic overlay 35 provides information to the viewer that may not be readily ascertainable from viewing the video image 12B of the activity occurring in the hockey game, and preferably occupies only a minor portion (i.e., less than 20%) of the video image. The enhanced graphic overlay 35 provides some information that is similar to that provided by the prior art graphic overlay 16B of FIG. 1B. For example, the enhanced graphic overlay 35 identifies the competing teams 37 (conventionally the home team is listed under the away team); the score 39; the period 43; the remaining time 45 in the period; indicia 47 that one or more players is occupying the penalty box (i.e., the words “PWR PLAY”); the remaining time 49 for the player to occupy the penalty box; and the identity of the broadcaster 51 providing the broadcast. The team 37 benefiting from the power play (i.e., the team with more players on the ice) is distinguished from the other team, for example, by highlighting the team 37 in a different color or using an asterisk as shown.

As shown in FIG. 2B, the graphic overlay 35 shows by the indicia 47 that one or more players are occupying the penalty box and the identity of the broadcaster 49. Unlike the prior art graphic overlay 16B of FIG. 1B, the inventive graphic overlay 35 also provides information or indicia 53 relating to the identity of the player or players currently occupying the penalty box. In one embodiment, as shown in FIGS. 2B and 3B, the identity information provided are the uniform numbers of the hockey player or players occupying the penalty box. As shown by indicia 53, a single player assigned uniform number 15 is presently occupying the penalty box (PB). The designation PB may or may not be included in the graphic overlay 35.

Other indicia relating to the identity of the hockey players currently occupying the penalty box is contemplated by the present invention, in place of or in addition to a uniform number. For example, photos or images of the players' faces can be provided at the locations of indicia 53. The player's position might be indicated, for example left wing (LW). Of course, the expected size of the viewer's screen 14B may influence the detail that might be provided by such photographs or other indicia.

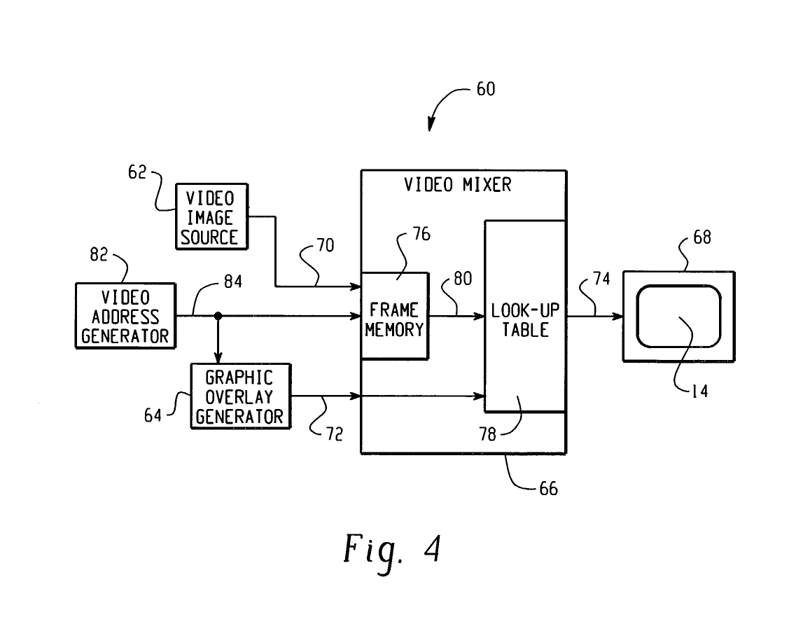

Systems for generating video images and for creating graphic overlays for the video images, such as those shown in FIGS. 1A and 1B, are known in the art. Two such systems are shown in U.S. Pat. Nos. 4,580,165 and 5,883,610, which are incorporated herein as if they had been fully set forth. Such systems may be used, together with the inventive features of the present invention, to create the graphic overlays in FIGS. 3A and B, and the combined video image and graphic overlay shown in FIGS. 2A and 2B. FIGS. 4 through 6, descriptions of which follow, provide the functional block diagrams of such a system for use in generating the graphic overlay and the combined video image and graphic overlay shown in FIGS. 2A, 2B, 3A, and 3B.

FIG. 4 shows a system 60, used to provide the enhanced graphic overlays 36 and 35, as shown alone in FIGS. 3A and 3B, respectively, and the combine video image and graphic overlay shown in FIGS. 2A and 2B, respectively. The system 60 comprises a video image source 62, a graphic overlay generator 64, a video mixer 66 for overlaying the enhanced graphic overlay 35 or 36 onto the video image 12B or 12A (or for combining the graphic overlay 35 or 36 and the video image 12B or 12A), and a video display monitor 68. The video display monitor 68 provides the viewing screen 14A or 14B shown in FIGS. 2A and 2B.

The video image source 62 may be a video camera, for providing a live (real-time) image of a sporting event such as a baseball game or hockey game, or may be some other type of source of a video signal, such as a videotape or digital video disc (DVD) player. The video image source 62 outputs a video image signal 70 to the video mixer 66. The video image signal 70 represents the video image 12A or 12B shown in FIG. 2A or 2B.

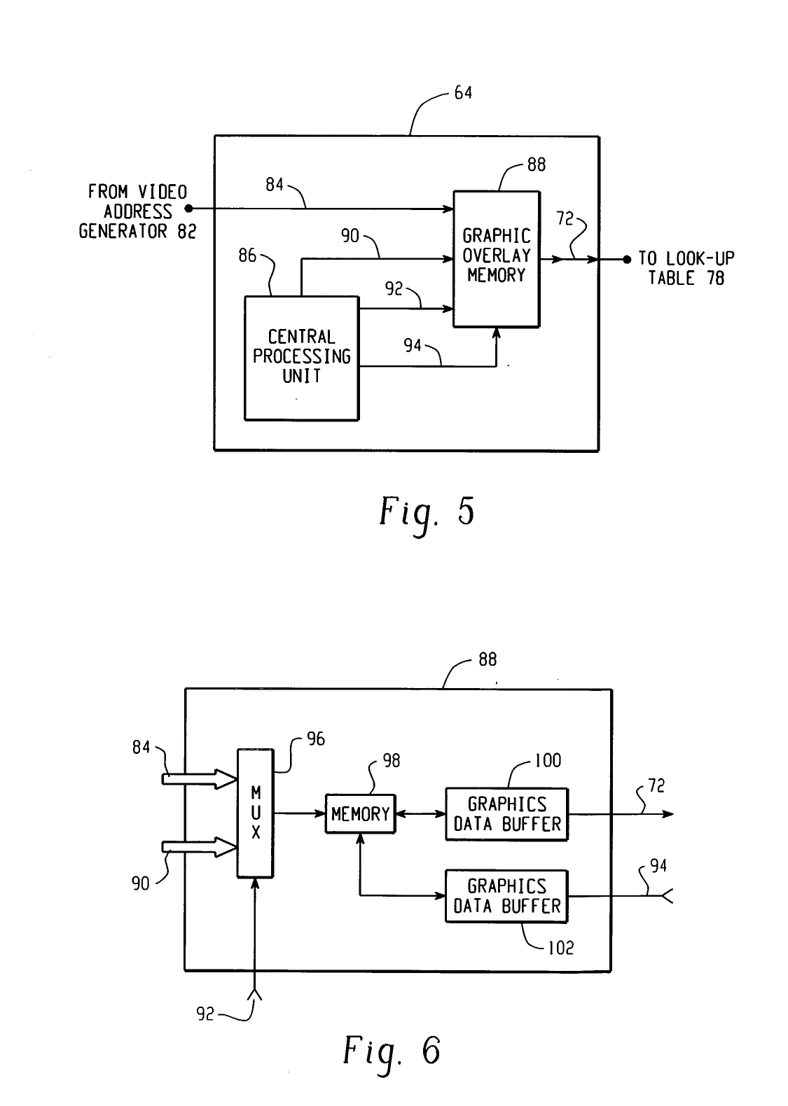

The graphic overlay generator 64 (shown in greater detail in FIGS. 5 and 6), outputs a video graphics signal 72 to the video mixer 66. The video graphics signal 72 represents the enhanced graphic overlay 36 or 35 in FIGS. 2A and 2B, respectively. The video graphics signal 72 includes information required to generate the enhanced graphic overlay 35 or 36, including information related to the identity of players. The video mixer 66 receives the video image signal 70 and the video graphics signal 72 and outputs a combined or mixed video signal 74 to the video display monitor 68.

The video mixer 66 includes at least a frame memory 76 for storing the video image signal 70 and outputting a stored video image signal 80. A lookup table 78 receives the stored video image signal 80 and the video graphics signal 72, overlays the video graphics signal onto the stored video image signal 80, and outputs the mixed video signal 74 to the video display monitor 68. Alternatively, the video mixer 66 may be constructed by any means known in the art that will enable the video graphics signal 72 to be overlaid onto the video image signal 70, and the output mixed video signal 74 to be provided to the video display monitor 68.

If the video mixer 66 shown in FIG. 4 is utilized in practicing the present invention, a video address generator 82 is used to generate addresses, and to provide these addresses to both the graphic overlay generator 64 and the frame memory 76, via video address signal 84. The video address signal 84 designates a location in frame memory 76 (or graphic overlay memory 88 described below) which the video data (or graphic overlay data) is to be read from or stored in. The frame memory 76 may be configured to perform reading and storing operations simultaneously using a dual port random access memory (RAM) device. The video address generator 82 may also provide information related to the position that the enhanced graphic overlay 36 or 35 should be overlaid upon the video image 12A or 12B.

FIG. 5 shows in greater detail one embodiment of the graphic overlay generator 64 shown in the system of FIG. 4. It is contemplated, however, that the graphic overlay generator 64 may be constructed by any means known in the art that will enable the generation and output of video graphic signal 72 to the video mixer 66. As shown in FIG. 5, the graphic overlay generator 64 comprises a central processing unit or CPU 86 and a graphic overlay memory 88. The video address signal 84 is provided to the graphic overlay memory 88 by the video address generator 82. Also provided to the graphic overlay memory 88 are a graphics address signal 90, a select control signal 92, and a graphics data signal 94, all three of these signals being provided by the CPU 86. Alternatively, the graphics data signal may be provided by an external source (not shown).

The graphics address signal 90 designates a location in the graphic overlay memory 88 from which the graphics data is to be stored in or retrieved. The graphic overlay memory 88 may be configured to perform reading and storing operations simultaneously using a dual port random access memory (RAM) device. The select control signal 92 controls the storing and reading operations of the graphic overlay memory 88. The graphics data signal 94 represents data that in part forms the video graphics signal 72. Video graphics signal 72 is output by the graphic overlay memory 88 and provided to the look-up table 78 in the video mixer 66. Referring back to FIG. 4, the look-up table 78 outputs the mixed video signal 74 obtained from overlaying the video graphics signal 72 from the graphic overlay generator 64 and the stored video image signal 80 from frame memory 76.

FIG. 6 shows in greater detail the graphic overlay memory 88 shown in the graphic overlay generator 64 of FIG. 5. As shown in FIG. 6, the graphic overlay memory 88 comprises a multiplexer 96, memory 98, first graphics data buffer 100, and second graphics data buffer 102. It is contemplated, however, that the graphic overlay memory 88 may be constructed by any means known in the art that will enable the generation and output of video graphic signal 72 to the video mixer 66.

The multiplexer 96 receives the video address signal 84 and the graphics address signal 90, and outputs one of these two addresses depending upon the state of the select control signal 92 output by CPU 86. Memory 98 contains the graphics data (such as player identification information) which is read from or written to memory 98, depending upon the output of multiplexer 96. First graphics data buffer 100 buffers and outputs video graphic signal 72 from the memory 98 to look-up table 78. Second graphics data buffer 102 buffers and outputs graphics data signal 94 to the memory 98 from the CPU 86.

The graphic overlay memory 88 of FIG. 6 operates as follows. If the select control signal 92 output by CPU 86 is high (or one state), the multiplexer 96 outputs a video address provided by video address generator 82, and memory 98 outputs graphics data designated by the address to first data graphics buffer 100. The first data graphics buffer 100 buffers the graphics data and then outputs it to the look-up table 78. If, however, the select control signal 92 output by CPU 86 is low (or an opposite state), the multiplexer 96 outputs a graphics address provided by the CPU 86, and memory 98 stores graphics data transmitted from second data graphics buffer 102 in the location designated by the address, thereby renewing the contents of memory 98.

Accordingly, a preferred embodiment of a method and system for enhancing graphic overlays on video images has been described. With the foregoing description in mind, however, it is understood that this description is made only by way of example, and that the invention is not limited to the particular embodiments described herein. For example, the system 60, shown and described in FIGS. 4-6 and used to provide the enhanced graphic overlay and video image shown in FIGS. 2A and 2B, may be any number of known systems that are typically used to provide graphic overlay images on top of, or overlaid upon, video images. It is further understood that various rearrangements, modifications, and substitutions may be implemented with respect to the foregoing description without departing from the scope of the invention as defined by the following claims and their equivalents.

I claim:

1. A method of broadcasting activity occurring in a sporting event, wherein the activity includes one or more players actively or inactively involved in the sporting event, comprising the steps of:
(i) providing a video image of activity occurring in the sporting event;
(ii) creating a graphic overlay for the video image, the graphic overlay providing indicia representing identity information of the one-or more players actively or inactively involved in the sporting event; and
(iii) combining the graphic overlay and the video image to create a combined image comprising the graphic overlay and the video image.

2. The method of claim 1, wherein the sporting event is a baseball game, wherein the activity includes one or more base runners occupying bases in a field where the baseball game is being played, and wherein the step of creating a graphic overlay for the video image includes providing for the graphic overlay indicia representing identity information of the one or more base runners occupying the bases.

3. The method of claim 2, wherein the step of combining the graphic overlay and the video image comprises the step of overlying the graphic overlay over only a minor portion of the video image.

4. The method of claim 2, wherein the step of providing a video image comprises providing a real-time image of activity occurring in the baseball game.

5. The method of claim 2, wherein the indicia representing identity information of the one or more base runners occupying bases is provided in the form of uniform numbers of the base runners.

6. The method of claim 2, wherein:
(i) the step of providing a video image of activity occurring in the baseball game comprises generating a video image signal using a video image source;
(ii) the step of creating a graphic overlay for the video image comprises the step of generating a video graphic signal using a graphic overlay generator; and
(iii) the step of combining the graphic overlay and the video image to create a combined image comprising the graphic overlay and the video image comprises the step of mixing the video image signal and the video graphic signal using a mixer.

7. The method of claim 1, wherein the sporting event is a hockey game, wherein the activity includes one or more players occupying a penalty box where the hockey game is being played, and wherein the step of creating a graphic overlay for the video image includes providing for the graphic overlay indicia representing identity information of the one or more players occupying the penalty box.

8. The method of claim 7, wherein the step of combining the graphic overlay and the video image comprises the step of overlying the graphic overlay over only a minor portion of the video image.

9. The method of claim 7, wherein the step of providing a video image comprises providing a real-time image of activity occurring in the hockey game.

10. The method of claim 7, wherein the indicia representing identity information of the one or more players occupying the penalty box is provided in the form of uniform numbers of the players.

11. The method of claim 7, wherein:
(i) the step of providing a video image of activity occurring in the hockey game comprises generating a video image signal using a video image source;
(ii) the step of creating a graphic overlay for the video image comprises the step of generating a video graphic signal using a graphic overlay generator; and
(iii) the step of combining the graphic overlay and the video image to create a combined image comprising the graphic overlay and the video image comprises the step of mixing the video image signal and the video graphic signal using a mixer.

12. A system for of broadcasting activity occurring in a baseball game, wherein the activity includes one or more base runners occupying bases in a field where the baseball game is being played, comprising:
(i) a video image source for providing a video image signal representing activity occurring in the baseball game;
(ii) a graphic overlay generator for creating a graphic overlay for the video image in the form of a video graphic signal, the graphic overlay providing indicia representing identity information of the one or more base runners occupying bases; and
(iii) a video mixer for combining the graphic overlay and the video image to create a combined image comprising the graphic overlay and the video image.

13. The system of claim 12, wherein the graphic overlay covers only a minor portion of the video image.

14. The system of claim 12, wherein the video image signal is a real-time image signal of activity occurring in the baseball game.

15. The system of claim 12, wherein the indicia representing identity information of the one or more base runners occupying bases is provided in the form of uniform numbers of the base runners.

16. A system for of broadcasting activity occurring in a hockey game, wherein the activity includes one or more players occupying a penalty box where the hockey game is being played, comprising:
(iv) a video image source for providing a video image signal representing activity occurring in the hockey game;
(v) a graphic overlay generator for creating a graphic overlay for the video image in the form of a video graphic signal, the graphic overlay providing indicia representing identity information of the one or more players occupying the penalty box; and
(vi) a video mixer for combining the graphic overlay and the video image to create a combined image comprising the graphic overlay and the video image.

17. The system of claim 16, wherein the graphic overlay covers only a minor portion of the video image.

18. The system of claim 16, wherein the video image signal is a real-time image signal of activity occurring in the hockey game.

19. The system of claim 16, wherein the indicia representing identity information of the one or more players occupying the penalty box is provided in the form of uniform numbers of the players.

20. An improved graphic overlay for a video image of activity occurring in a baseball game, wherein the activity includes one or more base runners occupying bases in a field where the baseball game is being played, the improved graphic overlay providing indicia representing identity information of the one or more base runners occupying bases.

21. The improved graphic overlay of claim 20, wherein the indicia representing identity information of the one or more base runners occupying bases is provided in the form of uniform numbers of the base runners.
